(19) United States
(12) Patent Application Publication
(10) Pub. No.: US 2010/0036717 A1
(43) Pub. Date: Feb. 11, 2010

(54) Dynamic Information System

(76) Inventor: Bernard Trest, Toronto (CA)

Correspondence Address: Bernard Trest, 76 Castlebury Cre., #3, Toronto, ON, M2H1W8, CA

(21) Appl. No.: 11/722,522

(22) PCT Filed: Dec. 29, 2005
(86) PCT No.: PCT/CA05/01979

§ 371 Date: Feb. 2, 2009

Related U.S. Application Data
(60) Provisional application No. 60/640,003, filed on Dec. 29, 2004.

(51) Int. Cl. G06Q 30/00; G01S 1/00; G10L 13/08

(52) U.S. Cl. 705/14.1; 705/14.49; 705/14.61; 705/14.5; 342/357.09; 705/14.63; 704/260

(57) ABSTRACT

A method for presenting dynamic advertising comprises providing an advertising presentation device; regularly receiving electronic context data related to the advertising presentation device; on the basis of the context data, automatically generating context-based advertising; and causing the advertising presentation device to present the context-based advertising. The method is useful in particular for mobile advertising presentation devices, as it enables advertising to be dynamically generated based on regularly received context data such as presentation device location, date/time, user input at the advertising presentation device. Increased relevance of the advertisement to the observer is therefore provided. A system for presenting dynamic advertisements comprises an advertising presentation device; a controller in communications with the advertising presentation device, the controller for: regularly receiving electronic context data related to the advertising presentation device; automatically generating context-based advertising on the basis of the context data; and causing the advertising presentation device to present the context-based advertising.

### FIELD OF THE INVENTION

The systems and methods disclosed herein relate generally to automatic presentation of information, and more particularly to a method and system for automatically presenting dynamic advertising.

### BACKGROUND OF THE INVENTION

Static advertising, such as that presented on printed signs, billboards and the like, has numerous limitations. One such limitation is the amount of information that can be presented at any time. Modifying static advertising to, for example, reflect new pricing or weekly specials can be physically difficult, time-consuming and expensive. Another drawback to static advertising is that its most effective placement for best exposure can be difficult to determine. Similarly, it is very challenging to determine advertising effectiveness once placement has been established. Also, in many cases, due to placement, the advertising must be designed in such a manner as to be broadly directed and therefore unfocused, as opposed to targeted to a specific market of consumers. As a result, the advertising is lacking relevance to many of its observers.

It is known to use static advertising in mobile implementations, such as a wrap placed on a vehicle's exterior, in order to bring the static advertising to consumers. However, particularly with these methods, viewers who see the vehicle in traffic may only have a short period of time to absorb the information contained in the mobile ad due to the movement of traffic.

Systems and methods have been proposed for mobile use that store a set of pre-determined advertising items in electronic memory, and that have location sensors in communications with a controller. Based on the sensed location of a vehicle to which a display device is affixed, the controller selects from the memory one of the pre-determined advertising items and displays it on the display device. For example U.S. Pat. No. 6,060,993 to Cohen discloses a mobile display system that comprises one or more vehicles, e.g. taxis, buses, tractor-trailers, etc., equipped with externally viewable display panels and an on-board controller. The controller determines the vehicle location and drives the display to generate a publicly viewable message selected for viewing within such location. The message is displayed pursuant to a schedule which includes date, time of day and display duration while the vehicle is within the zone or until the vehicle is located in another zone which is not included within the message schedule. A tiered system control network includes a plurality of fixed stations which transmit message content and scheduling data to the controller and which generate billing and other accounting records.

U.S. Pat. No. 6,236,330 also to Cohen discloses a mobile display system that comprises one or more movable billboard displays, equipped with externally viewable display panels and a controller. The display is moved from location zone to location zone by a transporter which may comprise a person or a vehicle. The controller ascertains the display location and drives the display to generate a publicly viewable message selected for viewing within such location zone. The message is displayed pursuant to a schedule which includes date, time of day and display duration while the display is within the zone or until the display is located in another zone which is not included within the message schedule. A tiered system control network includes a plurality of fixed stations which transmit message content and scheduling data to the controller and which generate billing and other accounting records. An advertiser may communicate with the network for creating and changing message content and scheduling data.

U.S. Pat. No. 6,545,596 to Moon discloses an advertising system including a mobile apparatus that determines location information and presents an advertisement based on the location information. The system may also include an output device that presents a selected advertisement based on audience information associated with mobile advertising targets.

U.S. Pat. No. 6,898,517 to Froeberg discloses a method and system for dynamically targeting content (e.g., advertising) displayed by a moving vehicle according to the location and direction of travel of the vehicle. Multiple items of content are loaded onto the vehicle and updated at periodic intervals. Position information (such as Global Positioning System information) is used to determine the location and direction of travel of the vehicle. Using the vehicle's position and direction of travel, and perhaps the time of day, a particular item of content can be selected and displayed to an audience external to the vehicle. The amount of time each particular item of content is displayed can be measured and used as the basis for billing clients.

The prior art methods and systems for selecting an advertising item based on location, date/time, weather and other factors provide improved options for better targeting markets of interest. However, in order for such systems to be effective, the designer is required to pre-define a very large number of complete advertisements for selection, and map them to the variables or combinations thereof. This process is extremely costly and time-consuming, but the drawback to not pre-defining a large number of advertisements is provision of advertising with only slightly more relevance than static advertising.

### SUMMARY OF THE INVENTION

According to one aspect, there is provided a method of presenting dynamic advertising, comprising:
providing an advertising presentation device;
regularly receiving context data related to the advertising presentation device;
on the basis of the context data, automatically generating context-based advertising; and
causing the advertising presentation device to present the context-based advertising.

The context data may comprise data related to a location of the advertising presentation device, and/or comprise data related to at least one person and/or vehicle proximate to the advertising presentation device. The context data may comprise data related to the advertising presentation device that is obtained from another source, such as weather data.

The generating may comprise combining a first predefined advertisement item that relates to the context data with a second predefined advertisement item. Alternatively, or in some combination, the generating may comprise creating, in real time, at least one of text, images, video, audio advertising components and/or receiving information related to the context data.

According to another aspect, there is provided a system for presenting dynamic advertising, comprising:

an advertising presentation device;

a controller in communications with the advertising presentation device, the controller for:
regularly receiving context data related to the advertising presentation device;
automatically generating context-based advertising on the basis of the context data; and
causing the advertising presentation device to present the context-based advertising.

The advertisement presentation device may be a visual advertising presentation device and/or an audio advertising presentation device.

The controller may comprise an input interface configured to receive the context data. The controller may further comprise a storage device storing electronic files for use during the generating.

According to yet another aspect, there is provided a computer readable medium embodying a computer program for operating an advertising presentation device, the computer program comprising:

computer program code for regularly receiving electronic context data related to the advertising presentation device;

computer program code for, on the basis of the context data, automatically generating context-based advertising; and computer program code for causing the advertising presentation device to present the context-based advertising.

According to still another aspect, there is provided a method of presenting dynamic advertising, comprising:

providing an advertising presentation device in communication with a controller;

the controller regularly receiving electronic context data related to the advertising presentation device;

the controller automatically generating context-based advertising on the basis of the context data; and

the controller causing the advertising presentation device to present the context-based advertising.

The methods and systems described herein have numerous advantages. For example, in order to be effective, prior art systems that merely select one of numerous advertisement items depending on location, date/time and the like require pre-definition of particular advertisement items in their entirety so that they are available for selection. A benefit of the invention is its ability to selectively target advertising based on one or more criteria represented by context data. The methods and systems described herein provide advertising that are automatically generated on the basis of the context data that is regularly received and thus may be generated just prior to or even during presentation. The systems and methods enable at least the dual benefits of increased relevance of advertising and the option of decreased pre-definition of advertisement items.

### BRIEF DESCRIPTION OF THE DRAWINGS

Embodiments will now be described more fully with reference to the accompanying drawings, in which:

FIG. 1 is an elevational view of the system for presenting mobile advertising that is affixed to a car, according to one embodiment;

FIG. 2 is a schematic diagram of the system for presenting mobile advertising, according to an embodiment;

FIG. 3 is a block diagram showing a proximity of a vehicle having a dynamic advertising system to one of several locations of a chain of restaurants;

FIG. 4 is a block diagram showing a vehicle having a dynamic advertising system in one of several zones; and

FIG. 5 is a block diagram showing a vehicle having a dynamic advertising system on one of several zones that have been mapped to average income.

### DETAILED DESCRIPTION OF THE EMBODIMENTS

Described herein is a method and system for presenting dynamic advertising. The method comprises providing an advertising presentation device; regularly receiving context data related to the advertising presentation device; on the basis of the context data, automatically generating context-based advertising; and causing the advertising presentation device to present the context-based advertising.

Some of the terms used in this specification are defined as follows:

“Advertising presentation device” is a device or device combination for presenting visual and/or audio advertising and other information. Examples of visual devices include image screens, video screens, and scrolling text devices. Examples of audio devices include speakers and radio transmitters. Further examples of advertising presentation devices and device combinations are provided herein.

“Context data related to the advertising presentation device” is any data that is usable to generate advertising in a relevant frame of reference for an observer of the advertising presentation device. Examples of such context data include location, date/time, a user's inputs etc. Further examples of context data are provided herein, or may otherwise be contemplated by one of ordinary skill in the art in view of the examples disclosed herein.

“Regularly receiving” is receiving in any one of or a combination of real-time, intermittently, periodically, continuous etc. The receiving of context data may depend on the nature of the context data. For example, where a vehicle that is affixed with the system of the invention is stationary, location context data will not change and, depending on the implementation, may not be received during the period in which there is no change.

“Generating” is creation of advertising, and may comprise but not consist entirely of selecting one or more advertisement items for presentation. For example, advertising may be generated by combining multiple pre-defined advertisement items into a relevant whole for an observer based on the context data. As another example, advertising may be generated by combining a pre-defined advertisement item with real-time direction data based on location context data. Further examples of generating will be provided herein.

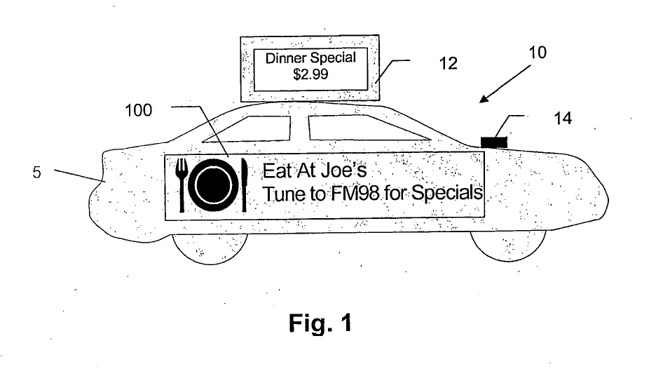

The invention will now be described with reference to the preferred embodiment shown in FIG. 1, which is an elevational view of a system 10 for presenting dynamic advertising that is affixed to a car 5, according to one embodiment. System 10 includes advertising presentation devices in the form of a video output device 12 and an audio output device 14, both coupled to a controller 16 (not shown in FIG. 1). Preferably, video output device 12 is a large LCD screen, and audio output device is a short-range radio transmitter. In FIG. 1, static exterior advertising 100 of a typical wrap nature is also affixed to car 5, and is used to instruct viewers to tune to a pre-selected radio station to obtain more information which can be supplied by the radio transmitter.

Video output device 12 is attached to car 5 using magnets (which may be removable), as a permanent installation, to a pre-existing or installed roof rack or roof rail or roof carrier or trunk carrier (which may be removable), or by some other means. Preferably, video output device 12 is enclosed, to protect it against damage, weather, theft, vandalism, and other potential problems.

Audio output device can be affixed to car 5 in any similar manner. A benefit of audio output device 14 is its ability to often provide more advertising and other information than can be presented visually. This is especially important in traffic, where car 5 may only be visible to another driver or pedestrian for a short period of time. The use of a short-range radio transmitter audio output device 14 allows information to continue to be presented to an audience even if the audience only sees the vehicle for a short period of time.

Certain factors are taken into consideration when audio output device 14 is a short-range radio transmitter. For example, laws in some jurisdictions may limit the broadcast power of the transmitter. This issue is addressed by having location device 22 determine the location of audio output device 14, and controller 16 consult a database that determines the maximum broadcast power that is legally allowed at the location of audio output device 14. Another consideration is that the radio transmitter audio output device 14 may conflict with existing broadcast radio stations. This problem may be addressed by obtaining location data from the location device 22 and, in conjunction with a database associating frequencies to location, determine which frequencies are in use at the location of audio output device 14, and otherwise avoid broadcasting on those frequencies. Alternatively, the invention may employ a sensor that detects which frequencies are already in use, and avoid broadcasting on those frequencies.

Audio output device 14 and video output device 12 can be used to present a combined audio/video ad, for example to show an MPEG4 movie trailer on video output device 12 while audio output device 14 outputs the movie soundtrack that is part of the same MPEG4 file. Alternatively, audio output device 14 and video output device 12 can be used independently, for example to show a still image on video output device 12 while audio output device 14 outputs an MP3 audio file.

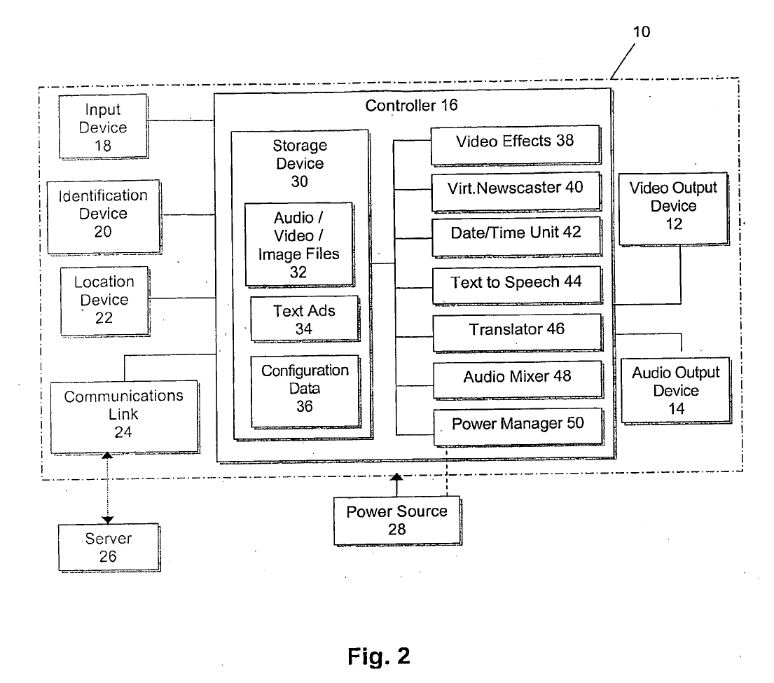

FIG. 2 is a schematic diagram of system 10, preferably implemented at least in part using software running on a portable personal computer. System 10 includes programmable controller 16 as shown in communication with video output device 12 and audio output device 14.

Programmable controller 16 regularly receives context data from one or more of user input device 18, identification device 20, location device 22 and server 26 through a network via communications link 24, as will be described. Programmable controller 16 may also receive additional advertisement items, updates of advertisement items, or configuration data in the same manner via communications link 24, and/or externally generated advertisement items, in addition to the context data. Programmable controller 16 may also dynamically generate text, images, video, audio, or other advertisement items. For example, directions and maps from a location of the advertising presentation device to the advertiser's nearest location and/or relevant event times could be presented, as will be described. As another example, up-to-date stock quotes or weather forecasts or other information could be presented. As another example, information could be associated with, and therefore personalized by vehicle, by viewer, or by some other criteria.

User input device 18 receives personal information from an observer of the advertising presentation device. For example, the observer can provide credit card information, fingerprint identification, DNA identification, retinal scans, or speak into user input device 18 to provide voice prints.

Identification device 20 identifies vehicles, people, and/or other things in the proximity of the advertising presentation device using some combination of a visual recognition (using a camera or some other image sensing device), facial identification, DNA identification, body type identification (male/female, body mass, and/or some other criteria), Radio Frequency identification (RFID) tags (carried on the person or in the vehicle or elsewhere), cell-phone identification (using a cell phone's Electronic Serial Number (ESN) or some other form of cell phone ID to identify the person and/or vehicle carrying the phone, by matching the cell phone ID to a database or by some other means), and/or by some other means.

Inputs may be provided to user input device 18 or identification device 20 directly by a user, via WiFi, Bluetooth, wire connection (i.e. USB) or other such connection. A portable electronics device such as a personal digital assistant (PDA) or cell phone could be used to provide inputs.

Location device 22 may be a Global Positioning System (GPS) device in communications with a satellite, an inertial tracking device, a cellular-based location device, or some other device capable of determining the location of the vehicle. These devices may optionally be used in some combination (with multiple of the same type of device and/or different types of devices) as a single combined location device in order to increase the accuracy and/or reliability and/or availability of location device 22. Optionally, location device 22 may also involve a server (such as server 26 or one with which server 26 is in communications) as part of its operation, for example an Advanced GPS (AGPS) device. Optionally, location device 22 could use a plurality of fixed and/or mobile stations to determine location using a wireless network or by some other means where, for example, satellite communication is not possible.

Communications link 24 enables provision of updates to stored audio/video advertisement items 32 or 34, and/or configuration data 36, stored in storage device 30. Communications link 24 may be a cellular link, a radio, a satellite link, a wireless network (linked to fixed or mobile stations or otherwise implemented by some other means), or some other type of communications device. Communications link 24 enables communication with server 26 for updating the audio/video advertising items using any one of a number of methods.

For example, a connection to server 26 could be periodically made (for example, once per day) via communications link 24, to check for new or modified audio/video advertisement items. If there are new or modified advertisement items, then only the new or modified advertisement items are downloaded to storage device 30. By limiting downloading to only new or modified advertisement items, time, bandwidth and communications costs are reduced compared with simply downloading all audio/video advertisement items that exist on the server. Furthermore, advertisement items that are stored in storage device 30 but no longer exists on server 26 are automatically deleted in order to conserve storage space.

Alternatively, audio/video advertisement items are downloaded from server 26 via communications link 24 and presented immediately. The downloaded items may be placed in storage device 30 for later use.

Audio/video advertisement items may be sent directly to communications link 24, to be presented immediately and/or placed in storage device 30 for possible later use.

Other uses of communications link 24 may be contemplated by one of ordinary skill in the art, such as for updating the programming of programmable controller 16 where, for example, system 10 is placed on a subway train on which GPS may not function.

System 10 is powered by a mobile power source 28, which may be an internal battery/batteries, an external battery/batteries, a connection to car 5's electrical system, a solar panel, a fuel cell, a wind-powered generator, some other power source, or some combination of the aforementioned power sources. Since conservation of power is very important, system 10 also comprises power manager 50, the purpose of which is to stop audio/video presentation and place system 10 in a low-power mode when power source 28 is low in power (for example, if an internal battery is nearly drained). Power manager 50 re-activates audio/video presentation and returns system 10 to its normal mode when power source 28 is able to supply sufficient power (for example, if an internal battery has been recharged). Power manager 50 may also operate power source 28 based on context data such as location (for example, by placing system 10 in low-power mode when the vehicle is inside a garage), vehicle motion (for example, by re-activating the invention to full operation once the vehicle has left the garage), time (for example, by putting the invention into low-power mode at night, and re-activating the invention to full power in the morning), proximity of people and/or vehicles. Other context data may be used such as data indicating that car 5 has been parked for a certain period of time—system 10 would be re-supplied with power when vehicle motion is detected, for example by periodically polling location device 22.

Power manager 50 is also capable of powering down system 10 when its power source 28 is low. For example, if a battery in car 5 used to power system 10 is nearly drained, power manager powers down system 10 and re-activates power when it has sensed that the battery has been sufficiently recharged.

When power manager 50 powers down, all or selected components of system 10 may be powered down. Preferably, power manager 50 powers down components of system 10 responsible for presenting advertising, such as advertising presentation devices (i.e. video output device 12 and audio output device 14). Other parts of system 10 may still be kept active, for example if it is desired that system 10 update its advertising from server 26 while system 10 is otherwise powered down for the night and no advertising is being presented.

Programmable controller 16 comprises a storage device 30 for storing pre-defined advertisement items, such as audio/video/image files 32 (for example, files containing video and/or audio stored in MPEG1 or MPEG2 or MPEG4 or Microsoft Windows Media or MP3 or AVI or some other format, images stored in JPEG or GIF or TIFF or some other format), text ads 34, and configuration data 36. Storage device 30 may be RAM memory, flash memory, a hard drive, or any other type of storage or combination thereof suitable for storing and making retrievable the above-described items. Storage device 30 may also store portions of pre-generated advertising in association with context data for future selection.

Programmable controller 16 also comprises a processor (not shown) and a number of operational units used for generating and selecting advertising based on the context data received by programmable controller 16. The operational units include a video effects unit 38, a virtual newscaster 40, a date/time unit 42, a text to speech unit 44, a translator 46, and an audio mixer 48, as will be described.

Video effects unit 38 applies video effects such as integrated combinations of video advertisement items, or other visual effects before advertising is sent to video output device 12. Such visual effects may include fade-ins, zooms, cross-fades, backgrounds, or other effects. The video effects unit 38 functions to combine (i.e. overlay, sequence etc.) visual advertisement items, as well as create split-screen effects in order to provide simultaneous display of multiple visual advertisement items. For example, the processor of controller 16 could instruct video effects unit 38 to overlay a movie trailer advertisement item in the form of a video image file 32 retrieved by controller 16 from storage device 30 with a retrieved text ad 34 of related movie times. In another example, directions generated using location information from location device 22 to a second location could be added to an image file 34 of a map. In yet another example, a text weather forecast obtained from server 26 based on location context data could be displayed over a pre-defined background in the form of an image file 32.

Virtual newscaster 40 creates a “virtual newscaster” type of display (otherwise known as a computer-generated “talking head”) from pre-defined text advertisement items 34 or text input via communications link 24 for video presentation.

Date/time unit 42 keeps a current date and time for use by programmable controller 16. The processor of programmable controller 16 is able to obtain the current date and time for use in generating time- and/or date-sensitive advertising. For example, the information advertising a dinner special as shown on visual output device 12 in FIG. 1 is clearly time-sensitive, and would be presented only at or around dinner time.

Text to speech unit 44 receives text advertisement items 34 stored in storage device 30 or other text advertisement items via communications link 24 and automatically converts them into audio advertisement items for presentation by audio output device 14.

Translator unit 46 receives text ads 34 or other text advertisement items via communications link 24 and automatically translates them into a different language. This may be done via logic and translation data maintained in storage device 30 of programmable controller 16, or by communication of the text through communications link 24 to an external service. For example, if car 5 were in a location in which it was known that a large population of French-speaking people reside or otherwise dwell, a text ad 34 in storage device 30 that is in one language could, if necessary, be automatically processed by translator module 46 for conversion to French before being provided to video output device 12.

Audio mixer 48 functions to combine audio files 32 based on context data, set volume and stereo balance, and perform other functions. Audio mixer 48 may also apply special effects, for example reverb or chorus or echo, or perform other such manipulations of the audio before it is provided to audio output device 14. The audio mixer 48 may adjust output direction and/or balance and/or turning various outputs on/off and/or other factors based on ambient noise, or context data such as the proximity and/or distance of people to car 5.

Before presenting audio/video advertising, programmable controller 16 considers one or more criteria to select and/or generate audio/video advertising to present. Once audio/video advertising is being presented the process of considering, selecting and/or generating is continued automatically.

One or more of the audio/video advertisement items may be output as single, combined audio/video advertising. For example, this could be used to present a general audio/video advertisement item for an automotive dealership followed by an audio/video advertisement item that refers the observer to the nearest location of the dealership on the basis of location context information obtained from location device 22. To the observer, this would appear to be a single advertisement.

Programmable controller 16 contains programmable ad logic which selects audio/video advertisement items for direct output or advertising generating based on one or more items of context data and selection criteria. The selection criteria are determined by configuration data 36 stored in storage device 30. Configuration data 36 can be updated at any time through communications link 24 to change the selection criteria. The programmable ad logic may also be modified in the same manner, if required. Audio/video advertisement items are selected or generated based on received context data representing one or more the following criteria (in some combination): car position, date, time, context data supplied by server 26, car speed, viewer/listener response, interactive response, proximate vehicles, proximate people, or some other context data.

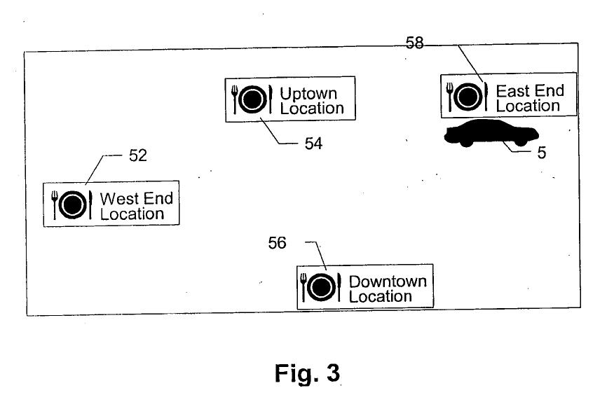

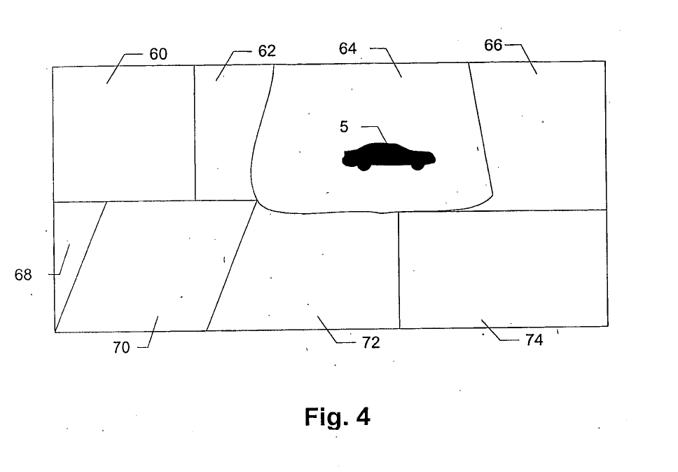

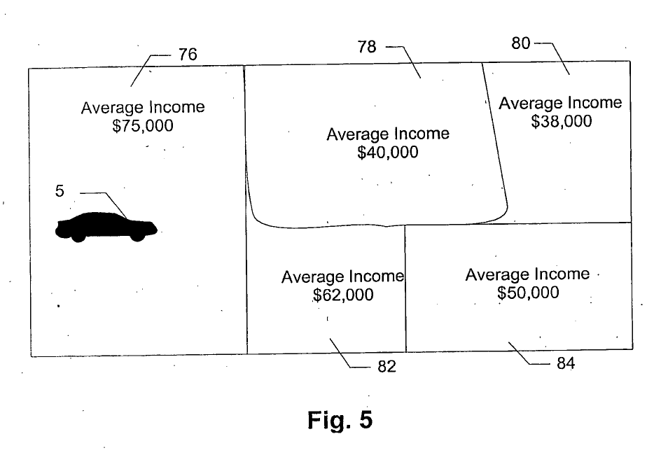

For car position, location context data is obtained from location device 22. This data may be utilized in one or more of the following manners (in some combination):
a) Location/Distance. This type of selection selects or generates audio/video advertising based on the closest one of a plurality of locations to car 5's location. FIG. 3 shows a typical use for this type of advertising selection. Here an advertiser—a restaurant—has four locations: West End 52, Uptown 54, Downtown 56, and East End 58. The advertiser is interested in referring people to the restaurant location closest to car 5. Storage device 30 contains a plurality of audio/video image file advertising items 32—one for each of the restaurant's four locations 52, 54, 56 and 58. Prior to presenting an audio/video advertising item, location device 22 is checked to determine the position of car 5. Car 5's distance to each restaurant location 52, 54, 56 and 58 is determined to find the closest restaurant location to car 5. This may be done using a direct distance calculation (for example, by computing the straight-line distance between car 5 and each restaurant location), by calculating the closest location using driving times and/or driving distances (for example, by using map data to determine the location that is the shortest driving distance and/or driving time away from car 5), and/or by some other means. Once the closest restaurant location has been determined, the audio/video advertisement item in storage device 30 that is associated with the closest restaurant location (in this case East End 58) is selected and caused to be presented by programmable controller 16. Optionally, directions to the nearest location could also be provided. For example, this could be done by programmable controller 16 incorporating software to determine the shortest and/or fastest route to the nearest restaurant location East End 58, then displaying a map and directions to the East End location 58 on video output device 12, and either sending the resulting text directions through the text-to-speech device 6 for conversion to audio for presentation, or presenting the text directions using RDS (Radio Data System) or some other system (or both). As another option, a maximum distance could be defined beyond which no location-based audio/video advertisement item is to be presented. For example, if car 5 is more than 50 miles from the advertiser's nearest location, the advertiser may wish to select and present a generic audio/video advertisement item (without mention of a specific location) due to the impractically long drive to the nearest location.
b) Street-based. This type of selection selects or generates audio/video advertising based on the vehicle's being on or near a certain street or streets.
c) Event-based. This type of selection selects or generates audio/video advertising based on the vehicle's proximity to an event hosting target people, for example a parade, street sale, or computer show. Information pertaining to the event (such as time and location) may be stored in a database in storage device 30 or determined remotely and provided using communications link 24 or by some other means. Programmable controller 16 accesses the database to determine if the advertising presentation device is in close proximity to an event whose participants an advertiser wishes to target, at the date and time the event is occurring. As an example, a computer store might want to target people attending a local computer show, since these people are likely to be interested in purchasing computer equipment. Programmable controller 16 would obtain location data from location device 22 and, in conjunction with date/time data obtained from date/time unit 42, determine whether the advertising presentation device is within a certain distance of the event location during the event. Appropriate advertising can then be presented, such as an advertisement item inviting people in the vicinity of the advertising presentation device to visit the computer show for a sale.
d) Area-based. FIG. 4 shows a typical use for this type of selection or generation of advertising. This type of selection or generation is based on division of a geographic region into a plurality of areas 60, 62, 64, 66, 68, 70, 72, 74 and selecting or generating advertising based on the area in which the car 5 is located as determined by location device 22. Storage device 30 contains a plurality of audio/video advertisement items, each stored in association with a respective area 60, 62, 64, 66, 68, 70, 72, 74. In FIG. 4, car 5 is located in area 64, so the audio/video advertisement item(s) corresponding to area 64 would be presented.
e) Specific area-based. This type of selection or generation works similarly to d) above, except that each area represents a pre-defined geographic or other region, for example a city, county, state or country.
f) Demographic/psychographic/data-based selection. This type of selection or generation is used when an advertiser wishes to target their audio/video advertising based on demographic data, psychographic data, customer purchasing profiles, or some other type of information. This type of selection or generation maps the position of car 5 (as determined by the location device 22) to one or more values as determined by data stored locally in storage device 30 or retrieved using communications link 24 or by some other means. The mapping may involve demographic data, psychographic data, customer profiles, or some other type of information. FIG. 5 illustrates a typical use for this type of selection. Here the position of car 5, as determined by location device 22, is mapped to a respective average income—one of $75,000 76, $40,000 78, $38,000 80, $62,000 82, and $50,000 84. The determined average income is used to select or generate for display audio/video advertising from a plurality of audio/video advertisement items stored in storage device 30, the audio/video advertisement item(s) being selected based on the average income of the area in which is car 5 is located. For example, this could be used by a car dealership to present an advertisement for their budget model in low-income areas, for their mid-sized model in mid-income areas, and for their luxury model in high-income areas. In FIG. 5, car 5 is positioned in the highest-income area $75,000 76, so audio/video advertising for the dealership's luxury model would be presented. As another example, this type of ad selection or generation could be used by a telecommunications company to present audio/video advertising representing different offers based on the cell phone usage of people in the same area in which car 5 is currently located.
g) Some other position-based criteria, as required by the advertiser and/or application.

Date is determined from date context data received from date/time unit 42. This information may be utilized in one or more of the following manners (in some combination):
a) Day of the week. For example, an advertiser may wish to advertise a special on Fridays only. As another example, an advertiser may advertise one product on weekdays while advertising a different product on weekends.
b) Day of the month. For example, an advertiser may wish to advertise a sale that occurs on the 15^{th} of each month.
c) Holidays. For example, the advertiser may wish to advertise Boxing Day specials.
d) Special days. For example, this could be used to advertise a special discount offered the last Tuesday of each month.
e) Some other date-based criteria, as required by the advertiser and/or application.

Time is determined by time context data received from date/time unit 42. For example, this type of advertising selection or generation could be used by a restaurant to present different audio/video advertising for breakfast specials, lunch specials, dinner specials, and late-night specials. As another example, this could be used by a movie theater to present upcoming showtimes for a particular movie.

Context data supplied by server 26 is obtained via communications link 24 from a network such as the Internet, or otherwise remotely determined and provided using communications link 24 or by some other means. For example, this data could be used to present different audio/video advertising based partly on the weather obtained from an Internet weather service. As another example, this could be used to present one of two different audio/video advertisement items based on whether a local sports team wins or loses. As another example, this could be used to provide viewers with current movie showtimes. As another example, this could be used to provide stock market or money market information.

Vehicle speed context data is determined in order to select or generate audio/video advertising of different lengths, so that if the vehicle is stopped in traffic, longer-running audio/video advertising will be presented, and if the vehicle is moving rapidly, shorter-running audio/video advertising will be presented to give viewers the opportunity to see it in its entirety. Vehicle speed information may be obtained from location context data received from location device 22, and date/time context data received from date/time unit 42, or from context data received directly from car 5.

Viewer/listener response context data is used to select or generate audio/video advertising based on the responses of people who have viewed the static exterior vehicle advertising 100 and/or have seen/heard the audio/video advertising for voluntary use. In this case, the invention would basically function as an interactive terminal. For example, it could be used to conduct a survey such that viewers who see the advertising are instructed to call a number and use a touch-tone phone to enter their opinion. This opinion information is then supplied back to programmable controller 16 via communications link 24, and is used to select or generate the audio/video advertising to present (in this case, the audio/video advertising that is presented would state the most recent results of the survey). For example, a user could obtain more information about advertising being output, could obtain coupons pertaining to an advertiser (to encourage the user to purchase the advertiser's product, for example), or obtain detailed driving directions and/or store hours to an advertiser's nearest location.

Alternatively, advertising could present a survey as to which of two products viewers favor, and invite observers to call two different cell phone numbers to participate (to entice observers to participate in the survey, a reward such as the possibility of winning a prize, or a discount on the advertiser's products, could be offered). Video output device 12 could then display the results of the survey, and then advertising could be automatically further targeted by presenting advertising for the favored product. As another example, an advertiser could run two different advertisement items during a given period of time, with system 10 alternating between outputting each advertisement item. Each advertisement item would present a respective cell phone number to call and/or a respective web site address to visit to obtain further information about that advertiser's products, which would be displayed by the video output device 12. Every time a person called one of the two cell phone number or visited one of the two web sites, server 26 or a server to which server 26 is connected logs that call or visit, thus determining which of the advertising is the most effective in generating a response. The log information is then used to either favor the more popular advertisement item(s), or to completely eliminate the less popular advertisement item(s). By this process, system 10 enables the determination as to which advertisement item is the most effective, and automatically adjusts the presentation of advertising accordingly.

Interactive response context data is used to select or generate audio/video advertising based on the voluntary or involuntary responses of a person near the vehicle by means of input device 18, which may be some combination of a proximity sensor, a microphone, a speech recognition device, a touch screen, a cell phone transceiver, a video camera capable of recognizing gestures or facial expressions or other visual criteria, a 3D touch screen, a virtual reality input device, and/or some other type of input device. An example of this type of selection is when a person approaches car 5, the proximity sensor activates audio/video presentation inviting the person to interact with system 10. The input of the person is context data used as the basis from which to select or generate audio/video advertising for presentation.

Where a cell phone transceiver is used, it will be understood that each cell phone has an identifier that uniquely identifies that cell phone, such as an Electronic Serial Number (ESN). Cellular phone companies typically have customer databases that relate a customer's name and other personal information to the ESN or other unique identifier. Therefore, system 10 may use such a database to personalize the advertising, either by using the information in that database on its own or by combining that information with information from another database. For example, if a person approaches system 10 carrying a cell phone, system 10 obtains the ESN of the person's cell phone, and uses it to obtain the name and other personal information of that person. This information is then cross-referenced with another database that contains information about the person's recent purchases. Therefore, if system 10 finds that the person purchases many music CDs, system 10 could select or generate advertising for a local CD store.

Preferably, system 10 employs one or more cameras (not shown) to capture images of people near the advertising presentation device. Image data collected by the camera(s) is analyzed to locate facial features, which are then compared against a database of facial features, thus identifying the person. System 10 can then target advertising to a person near the advertising presentation device, optionally by consulting additional databases to obtain more information about that person.

Proximate vehicle-based context data is used to select or generate advertising using identification device 20 to obtain information about nearby vehicle(s). This context data may be utilized in one or more of the following manners (in some combination):
a) Type of vehicle. For this type of selection or generation, identification device 20 determines the type and/or brand and/or make of a nearby vehicle. This information is then used to present targeted audio/video advertising. For example, this could be used to present targeted advertising for a high-priced product to drivers of luxury cars, while targeting advertising for a low-priced product to drivers of compact cars.
b) Number of people in the vehicle.
c) License plate information. For this type of selection or generation, a camera identification device 20 detects the license plate information of a nearby vehicle. Optical Character Recognition (OCR) or some other means is used to convert the license plate information into textual form. This textual form license plate information is then used to obtain information about the vehicle and its owners and/or drivers using communications link 24 or some other means. The information thus obtained is used to select or generate audio/video advertising for presentation.
d) Driver identification. Identification device 20 is used to identify the driver and/or passengers (if any) of the vehicle. This information can be used to personalize audio/video advertising.
e) Some other vehicle-based criteria, as required by the advertiser and/or application.

Person-based context data is used to select or generate advertising using identification device 20 to identify drivers and passengers of other vehicles, pedestrians, passers-by, and other people. The audio/video advertising to present is then selected or generated based on the context data related to the identified person. Further information about the person may be obtained from storage device 30 or obtained using communications link 24 or by some other means. Optionally, this type of identification can be used for tracking or other purposes, for example to study demographic patterns, to track customer information, or to identify wanted criminals or terrorists.

Other context data for use in advertising selection of generation may be used, as required by the advertiser and/or application. Optionally, system 10 could present untargeted advertising without using context data as selection criteria.

System 10 may be used to output information or other content that can be used to attract observers of advertising. For example, a news ticker displaying sports scores, stock information, breaking news, or other information obtained from storage device 30 and/or from a network via communications link 24 can be overlayed (by video effects unit 38) over audio/video advertising items being presented by video output device 12. As another example, an interesting video clip could be presented in a corner of video output device 12 along with the audio/video advertising. As another example, presentation of audio/video advertising can be interspersed with weather reports. Such extra content would be provided to attract observers and keep their attention, thereby increasing exposure of the audio/video advertising. Such a strategy could also be used to present public service announcements, such as road closure information, crime bulletins, or information about a missing person or wanted criminal or terrorist. This could also be used to supply information about a vehicle, for example to inform passers-by that a taxicab that carries system 10 is in service or out of service.

In order to provide advertisers with valuable information related to the travel of car 5 presenting their advertising and therefore exposure of the advertising, periodically (for example, every 15 seconds), location information of the car 5 is obtained from location device 22. The location information thus obtained, along with the dates and times at which the information was gathered (obtained from date/time unit 42), the speed of car 5, a unique code identifying car 5, information related to the presentation of the audio/video advertising (as examples, the number of times each audio/video advertisement item is output, the location of car 5 and time of day and date when each audio/video advertisement item is presented, etc.), and any other desired information, may be:

1. Immediately sent to server 26;

2. Stored in storage device 30 and periodically (for example, once per day) sent to server 26;

3. Stored in storage device 30 for later remote or local access; or

4. Some combination of the above.

This information could be used by an advertiser, for example, to determine that the advertiser's advertising work best when presented at certain locations and at certain times, thereby helping better target the advertiser's advertising in the future. This feature is also valuable for presenting different advertising, since the information collected can help determine which of the advertiser's advertising is most effective.

This information may also be used by an owner/operator of system 10 for billing advertisers. As would be understood, the information could be provided to advertisers by an Internet-based system, by some other type of on-line system, by a network, by fax, by phone, or by some other means.

The following is an illustrative example of collection of exposure information, in which an advertiser is a restaurant with three locations. When an advertisers logs into an advertising exposure-reporting web site, he/she will be a presented with a report such as the following:

TABLE 1
Date: Jun. 3, 2005

| | Time | | | |
|---|---|---|---|---|
| Location | Morning | Afternoon | Evening | TOTALS |
| Uptown | 142 | 231 | 223 | 596 |
| Downtown | 157 | 201 | 205 | 563 |
| East End | 109 | 194 | 183 | 486 |
| TOTALS | 408 | 626 | 611 | 1645 |

Table 1 is a simple example of advertising exposure reporting. In a practical implementation, such a table could present information for multiple days. Each value in Table 1 represents the number of times each advertisement item was presented in the proximity of each advertiser's location, as well as the times at which the presentation took place. This information is valuable to the advertiser because it can be used when comparing the increase in customers at each location to the number of times each ad was output. Upon examination of Table 1, it is clear that the East End restaurant location received the fewest advertisement item views. It can also be noted from Table 1 that advertisement items were less frequently presented during the morning.

When information similar to that shown in Table 1 is available to advertisers on a day-by-day basis, it can also be used to determine the most effective days to advertise, as well as to determine the effectiveness of different advertising. For example, if an advertiser ran one advertisement item for two days, then a different advertisement item for two more days, the number of times each separate advertisement item was presented during its run would be valuable in determining the effectiveness of each advertisement item.

Programmable controller 16 may function to switch frequencies, temporarily turn off (and turn on), and/or adjust output power of audio output device 14. For example, this could be used to keep audio output device 14 from interfering with a radio station transmitting in a given area when a vehicle enters that area, as determined from context data obtained from location device 22. As another example, this could be used to switch frequencies (and display for observers the new frequency using video output device 12), lower transmission power output, and/or temporarily turn off audio presentation (or some combination of the preceding) when the car 5 is within range of another similarly equipped vehicle, as determined using communications link 24 or by some other means.

Programmable controller 16 may be used to collect status information pertaining to any part of system 10, as well as any part of car 5. This information may be sent immediately over communications link 24 to server 26, or can be temporarily placed in storage device 30 for periodic (for example, once a day) upload to server 26. For example, it could be used to determine if car 5 has failed to travel a certain number of miles each month.

Programmable controller 16 can be used to present information to the operator of car 5, the information being sent to programmable controller 16 through communications link 24 and either output as audio and/or sent to a secondary presentation device. This option can be implemented as either a one-way link or a two-way link for communicating with the operator of car 5. For example, this could be used to inform the operator of car 5 that he/she has failed to drive a certain number of miles in a given month. As another example, this could be used to instruct the operator to deliver car 5 to a certain place at a certain time for purposes of modifying the vehicle exterior static advertising 100. As another example, this could be used by a central operations centre or the like to speak with the operator and provide instructions over a two-way link.

System 10 may present information to the operator of car 5 that enables the operator to consider routes that would optimize the effectiveness of the advertising being presented by system 10. For example, routing information based on location data supplied by location device 22 could be used to have the operator bring car 5 near advertisers' locations (or otherwise avoid routes that are far removed from any advertisers' locations). As another example, the routing information provided to the operator of car 5 could have the operator avoid sparsely traveled routes while favoring heavily trafficked areas, in order to increase the exposure of the advertising. As another example, the routing information supplied to the operator could favor affluent areas (see FIG. 5), thereby exposing the advertising to people with more discretionary income. As such, travel information is provided to the operator of car 5 to place the vehicle in optimum positions for its advertising to best reach its intended audience.

The systems and methods disclosed herein may serve a single advertiser exclusively, or multiple advertisers. When multiple advertisers share a single system, advertising presentation time is divided between the advertisers. For example, if six (6) advertisers share one system, then each advertiser's group of advertising items may be presented in either a fixed or random sequence. As another example, each advertiser's advertising could be presented a certain number of times each hour or each day. As a further example, the system could decide which advertiser's advertising to present based on the context data, such as location, the time of day, and/or other factors

While particular embodiments of the invention have been described, it will be understood that other embodiments may be conceived that are within the scope and purpose of the invention.

For example, while a mobile dynamic advertising system 10 affixed to an exterior of a car 5 has been described, an alternative implementation of the invention is as a display to be used in interior mobile advertising (for example, inside taxis or subways), interior advertising, exterior advertising (as examples: billboards, posters, garbage cans, recycling bins), or some other purpose. Such an alternative implementation can be used to replace advertising inside buses and subways, inside subway stations, inside stores and malls, outside to replace bus shelter and recycling bin displays, placed on a sidewalk or street corner, used as a replacement for posters or billboards, used as kiosks, placed at storefronts or inside stores, used as directories, or for other purposes.

The system described herein could be used to replace what would otherwise be a static display with dynamically-generated advertising. For example, this could be used by a chain of pizza outlets to tell riders on a subway which station they would have to get off at to get to the pizza chain's nearest location.

System 10 may also function as a sales/vending terminal, implemented using a touch screen input device 18, voice recognition, or by some other means that would allow a person to interact with the system 10. As an example, a person could use the system via input device 18 to order a pizza. Optionally, system 10 could incorporate a vending machine or other device for dispensing coupons, receipts, movie tickets in paper form such as a printer, or in electronic or some other form.

As another option, system 10 could be used to provide non-advertising content to a person from a network via communications link 24 or by some other means. For example, this could be used to provide samples of songs, which could then be purchased and downloaded to a portable MP3 player using a USB connection or a Bluetooth or WiFi wireless connection or by some other means.

As another option, system 10 could be used to sell Internet access via a wireless network, a USB connection, or some other means. To allow sales to occur, system 10 could, for example, request a person to enter credit card information via input device 18 or some other means.

Further options exist for use with system 10. For example, system 10 could enable a person to connect to a customer service representative or other person, via voice and/or video or other means, to allow the user of system 10 to obtain more information about a product or service, purchase a product or service, obtain assistance in using the invention, or for other purposes. Optionally, the system can offer Internet access, free phone calls, music files or other content, or other incentives to view the audio/video ads and/or interact with system 10. For example, system 10 could offer 10 minutes of free Internet access in return for completing a survey.

While the mobile embodiments have been described as affixed to a car, it will be understood that a mobile implementation can be affixed on and/or in trucks, minivans, sport utility vehicles, taxis, buses, motorcycles, bicycles, rickshaws, animals, humans, subways, trains, or other vehicles. Furthermore, although the invention is primarily intended for use in advertising and other promotional applications, it can also be used in other applications which require presentation of dynamic information.

While the video output device 12 has been described as preferably an LCD (liquid crystal display) output screen, it will be understood that other video output devices can be employed without departing from the spirit and scope of the invention. For example, such devices may be one or more of: a light-emitting diode display (LED), an organic light-emitting diode display (OLED), a light emitting polymer display (LEP), an electroluminescent display, a projector, a holographic output system, a 3D LCD display, a 3D LED display, a window-integrated display, a digital/dynamic/magnetic/electronic ink (e-ink) system, a 360° viewable or other wrap-around or wide-angle display, a flexible display, a plasma display, or some other device.

Furthermore, video output device 12 may be a single display or multiple displays in some combination. When video output device 12 is more than one display, the multiple displays can display the same output, and/or different outputs in some combination, and/or split an output over multiple displays, and/or be employed in some other fashion.

While placement of video output device 12 in mobile embodiments have been described as affixed to the exterior of a vehicle such as a car 5, it may be placed inside vehicle, and visible to observers through a window or other opening. In some cases, this type of placement would serve to make installation relatively fast and easy and low-cost, reducing or eliminating the need to modify the vehicle to accommodate video output device 12, and providing protection against weather and theft. Video output device 12 may employ or be used in conjunction with a polarizing filter or coating or screen (for example, by placing a polarizing filter on the exterior of a rear vehicle window while placing video output device 12 inside the vehicle facing outwards towards the rear window), an anti-glare filter or tint or coating or screen, or some other item, coating, or device designed to prevent glare when video output device 12 is viewed in sunlight, generally preventing presentation of a washed-out image, and improving the visibility of advertising on video output device 12.

Video output device 12 may have a light sensor that adjusts the brightness and/or contrast of the display based on lighting conditions and/or date/time data and/or other context data, to work in conjunction with power manager 50 to conserve battery power, optimize the appearance of the display and/or for other purposes.

Furthermore, a wiper or spray or some other means of keeping video output device 12 clean and visible when exposed to the elements may be used. A wiper/spray mechanism may either operate on a fixed schedule, or use a dirt or light sensor to detect when video output device 12 needs cleaning, or some combination of both.

Audio output device 14 has been described as preferably a short-range radio transmitter that transmits the audio produced by the programmable controller 16. However, audio output device 14 can be a longer-range radio transmitter, a speaker, a “whispering windows”-type device (which can convert a window or a vehicle's exterior or some other surface into a speaker), or some other device capable of outputting audio; these devices can be used singly or together in some combination. Audio output device 14 may also be capable of outputting text using RDS (Radio Data System) or some other system.

Where audio output device 14 is a speaker or the like, system 10 may employ a proximity sensor (not shown) to determine the distance of people from car 5 to which audio output device 14 is affixed. If a person is some distance from car 5, system 10 receiving corresponding data from the proximity sensor can turn up the volume of audio output device 14 so that the person can hear the audio presentation of the advertising. As the person approaches car 5, system 10 can progressively lower the volume of audio output device 14 since, as the person approaches, system 10 would not require the audio output to be played at a high volume. System 10 could also employ a sound sensor (not shown) that senses the decibel level of sounds around audio output device 14 and adjust the audio output volume accordingly. For example, in a quiet area the audio output volume could be low. As audio output device 14 is moved into a more noisy area (such as a construction site), audio output volume could be increased to compensate for the surrounding noise.

System 10 could be configured also to combine data from the proximity sensor and the sound sensor to determine a suitable volume for audio output device 14. For example, system 10 could turn the volume down low if a person was standing near audio output device 14 and in a quiet area, while turning the volume up considerably if the nearest person is some distance away from audio output device 14 and audio output device 14 is located in a noisy area.

Programmable controller 16 has been described as preferably implemented at least in part using software running on a portable personal computer. Controller 16 may be implemented, in whole or in part, with a laptop computer, tablet computer, automotive electronics, a PDA (personal digital assistant), a cell phone, an audio player, a video player, or some other suitable equipment. Programmable controller 16 may also be combined with other parts of the invention in a single suitable device. For example, programmable controller 16 and communications link 24 may be implemented by a programmable cell phone. As another example, programmable controller 16 and location device 22 may be implemented by a PDA with an integrated GPS unit. As another example, programmable controller 16 and communications link 24 and location device 22 may be implemented by a programmable cell phone with an integrated GPS/cellular-based location apparatus. As yet another example, programmable controller 16 and video output device 12 may be implemented by a tablet PC, with the tablet PC's display serving as the video output device.

Optionally, system 10 may have an additional camera/display system or other system that can assist the operator of the vehicle in operating the vehicle by enhancing visibility.

Since system 10 employs video output device 12, electronics and other equipment which may be sensitive to temperature variations and may not function properly in extreme temperatures, system 10 can optionally employ a heating/cooling unit for ensuring optimum operation of system 10 and its components. The heating/cooling unit uses a thermostat that maintains system 10 either at a fixed temperature or within a given temperature range. Keeping system 10 within a given temperature range is preferred to using a fixed temperature in order to conserve power, since most practical implementations of system 10 would be able to function across a range of temperatures. By keeping system 10 within its operable temperature range, rather than at a fixed temperature, the load on the heating/cooling unit is reduced and power is thereby conserved. As an example, the heating/cooling unit would only operate when the external environment is extremely hot or extremely cold, thereby allowing system 10 to operate correctly and activating the heating/cooling unit only when necessary.

As will be understood, implementation of the heating/cooling unit depends partly on the configuration chosen to implement system 10. According to one embodiment of the invention, all components are contained in a single physical package. As such, only a single heating/cooling unit is required. In other possible embodiments of the invention, different components of the invention may be physically separate, or combined together in some combination, necessitating different heating/cooling configurations. For example, video output device 12 and audio output device 14 may be contained in separate physical packages while other components of the invention (i.e. controller 16 etc.) are contained in another physical package. In this sort of implementation, separate heating/cooling units may be employed for some or for all parts of system 10.

System 10 can be used with one or more vehicles, with one or more systems placed in each vehicle. When multiple such systems are used, the programmable controller 16 of each system 10 is beneficially capable of using communications link 24 to communicate with the other programmable controllers. This feature is advantageous as it can be used to communicate information between systems, to let one system know when it's in the vicinity of another system, to distribute audio/video advertising and other information between systems, or for other purposes, such as frequency co-ordination of radio transmitters when multiple systems 10 are in close proximity. Furthermore, when two or more systems 10 are in close proximity, they may communicate to co-ordinate advertising and/or transfer advertisement items, travel data, and other information amongst themselves. Preferably, two systems 10 in close proximity communicate with each other using WiFi or some other means. If one system 10 detects that the other system 10 contains newer advertising (for example, as determined by the modification date of the advertising files 32 or 34), system 10 containing the newer advertising can transfer the newer advertising files to the system 10 with the older advertising, thereby updating the older advertising item files.

The purpose of the direct transfer described above is to increase bandwidth available for transferring data while reducing costs. System 10 will typically automatically update itself from a central server (such as server 26) using, for example, a cell phone data link. However, the problem with such a link is that it provides limited bandwidth and can be expensive, often incurring large additional charges when large amounts of data are transferred. System 10 addresses this concern by only updating its advertisement items infrequently from the central server (for example, every 2 days), while at other times obtaining advertisement items transferred from other systems 10 that are in close proximity using high-bandwidth WiFi or some other technology, thereby reducing the load on the server and reducing cell phone usage charges.

It will be understood that two systems 10 in close proximity may conflict with each other if their respective audio output devices 14 are broadcasting on the same frequency. This conflict may be avoided by some combination of the following two methods: Firstly, system 10 may utilize an additional sensor to determine which frequencies are already in use and which are available. Secondly, system 10 may communicate with other nearby system 10, using WiFi or Bluetooth or some other wireless means, to mutually negotiate an acceptable frequency that is not in use. If large numbers of systems 10 are in close proximity to one another, limiting the availability of broadcast frequencies, the systems 10 may also temporarily lower their broadcast power to avoid conflicting with other systems 10 that are some distance away and broadcasting on the same frequency.

Other alternatives may be contemplated by those of ordinary skill in the art and it will be appreciated that variations and modifications may be made without departing from the spirit and scope thereof as defined by the appended claims.

What is claimed is:

1. A method of presenting dynamic advertising, comprising:
providing an advertising presentation device;
regularly receiving context data related to the advertising presentation t device;
on the basis of the context data, automatically generating context-based advertising; and
causing the advertising presentation device to present the context-based advertising.

2. The method of claim 1, wherein the context data comprises data related to a location of the advertising presentation device.

3. The method of claim 1, wherein the context data comprises at least one of date and time of day at which the advertising presentation device is capable of presenting.

4. The method of claim 1, wherein the context data comprises weather at a location of the advertising presentation device.

5. The method of claim 1, wherein the context data is obtained from at least one person proximate to the advertising presentation device.

6. The method of claim 1, wherein the context data is obtained from a personal electronics device proximate to the advertising presentation device.

7. The method of claim 6, wherein the context data is obtained via one of a Bluetooth connection and a WiFi connection.

8. The method of claim 1, wherein the context data is obtained from at least one vehicle proximate to the advertising presentation device.

9. The method of claim 5, wherein the context data is one of credit card data, fingerprint data, DNA data, retinal scan data, video recognition data, facial recognition data, body type identification data, radio frequency identification data, portable electronic device identification data, voice print data.

10. The method of claim 5, wherein the context data provided by the at least one person is voluntarily provided by the at least one person.

11. The method of claim 5, wherein the context data provided by the at least one person is substantially involuntarily provided by the at least one person via an input device that is proximate to the advertising presentation device.

12. The method of claim 2, wherein the generating comprises determining a relationship between the location of the advertising presentation device and a second location and combining the relationship with a first predefined advertisement item.

13. The method of claim 3, wherein the generating comprises combining a first predefined advertisement item that relates to the at least one of date and time of day with a second predefined advertisement item.

14. The method of claim 4, wherein the generating comprises combining a first predefined advertisement item that relates to the weather with a second predefined advertisement item.

15. The method of claim 5, wherein the generating comprises combining a first predefined advertisement item that relates to the at least one person with a second predefined advertisement item.

16. The method of claim 1, wherein the generating comprises combining a first predefined advertisement item that relates to the context data with a second predefined advertisement item.

17. The method of claim 1, wherein the context data comprises data related to a location of the advertising presentation device and data related to current date and time.

18. The method of claim 17, wherein the data related to the location of the advertising presentation device is used to retrieve advertising information about a second location, and the data related to current date and time is used to retrieve advertising information about an event at second location.

19. The method of claim 18, wherein the second location is a theatre, and the advertising information about an event is at least one show start time at the theatre.

20. The method of claim 1, wherein the context-based advertising comprises an audible component.

21. The method of claim 1, wherein the context-based advertising comprises a visual component.

22. The method of claim 1, wherein the advertising presentation device is mobile.

23. The method of claim 1, wherein the advertising presentation device is stationary.

24. The method of claim 1, wherein the advertising presentation device comprises a video output device.

25. The method of claim 1, wherein the advertising presentation device comprises an audio output device.

26. The method of claim 1, wherein the causing comprises converting the context-based advertising into a format compatible with the advertising presentation device prior to presentation.

27. The method of claim 1, wherein the generating comprises creating, in real time, at least one of text, images, video, audio advertising components.

28. The method of claim 1, wherein the generating comprises receiving information related to the context data.

29. The method of claim 28, wherein the information is at least one current stock quote.

30. The method of claim 5, further comprising dispensing an item related to the context-based advertising for the at least one person.

31. The method of claim 30, wherein the item is one of a data file, a paper coupon, and a receipt.

32. The method of claim 31, wherein the item is created on the basis of the context data.

33. The method of claim 1, wherein the context-based advertising is a context-based combination of at least two stored advertisements.

34. The method of claim 1, wherein the causing comprises applying at least one visual effect to the context-based advertising.

35. The method of claim 1, further comprising:
storing portions of the context-based advertising in association with the context data for future selection.

36. A system for presenting dynamic advertising, comprising:
an advertising presentation device;
a controller in communications with the advertising presentation device, the controller for:
regularly receiving context data related to the advertising presentation device;
automatically generating context-based advertising on the basis of the context data; and
causing the advertising presentation device to present the context-based advertising.

37. The system of claim 36, wherein the advertising presentation device comprises a visual advertising presentation device.

38. The system of claim 37, wherein the visual advertising presentation device is a video output device.

39. The system of claim 38, wherein the video output device is selected from the group consisting of: a liquid crystal display, a light-emitting diode display, an organic light-emitting diode display, a light-emitting polymer display, an electroluminescent display, a projector, a holographic output system, a three-dimensional liquid crystal display, a three-dimensional light-emitting diode display, a window-integrated display, an electronic-ink system, a 360 degree viewable display, a wide-angle display, a flexible display, a plasma display.

40. The system of claim 38, wherein the video output device is coupled to a light sensor for sensing ambient lighting conditions, and the video output device automatically adjusts display qualities based on the sensing.

41. The system of claim 36, wherein the advertising presentation device comprises an audio output device.

42. The system of claim 41, wherein the audio output device is selected from the group consisting of a speaker, a radio broadcast transmitter, and a whispering-windows device.

43. The system of claim 41, wherein the audio output device is coupled to a sound sensor for sensing ambient sound conditions, and the audio output device automatically adjusts sound qualities based on the sensing.

44. The system of claim 36, wherein the controller comprises an input interface configured to receive the context data.

45. The system of claim 44, wherein the input interface is configured to receive context data from a location detection device selected from the group consisting of a global positioning system, an inertial tracking device, a cellular-based location device, an advanced global positioning system device.

46. The system of claim 44, wherein the input interface is configured to receive context data from a user-operated input device selected from the group consisting of a keyboard, a debit/credit card reader, a touch screen, a fingerprint reader, a DNA reader, a retinal scanner, video recognition system, facial recognition system, body type identification system, radio frequency identification system, a portable electronic device, voiceprint system.

47. The system of claim 44, wherein the input interface is configured to receive context data from a server via a computer network.

48. The system of claim 44, wherein the input interface is further configured to receive configuration data.

49. The system of claim 44, wherein the input interface is further configured to receive advertisement data.

50. The system of claim 36, further comprising:
a storage device storing electronic files for use during the generating.

51. The system of claim 50, wherein the electronic files comprise at least one of audio files, video files, image files, text files and configuration data files.

52. The system of claim 38, wherein the controller comprises a video effects unit for applying visual effects to the advertising.

53. The system of claim 38, wherein the controller comprises a virtual newscaster for receiving non-visual advertising and, in response, producing visual advertising.

54. The system of claim 36, wherein the controller comprises a date/time unit for providing a current date and time.

55. The system of claim 41, wherein the controller comprises a text-to-speech converter for receiving textual advertising and, in response, producing text advertising.

56. The system of claim 36, wherein the controller comprises a text translator for converting textual advertising into an alternate language.

57. The system of claim 41, wherein the controller comprises an audio mixer for applying audio effects to the advertising.

58. The system of claim 36, wherein the controller comprises a power manager for controlling the power consumption of the advertising presentation device based on the context data.

59. The system of claim 36, wherein the advertising presentation device is associated with an auxiliary output device in communication with the controller for dispensing at least one item related to the context-based advertising.

60. The system of claim 59, wherein the auxiliary output device is a printer.

61. The system of claim 59, wherein the auxiliary output device is a wireless transmitter.

62. The system of claim 36, wherein the advertising presentation device comprises a radio transmitter.

63. The system of claim 36, wherein the advertising presentation device comprises both a video output device and an audio output device.

64. The system of claim 36, wherein the context-based advertising is one of an MPEG file, a MS Windows Media file, an MP3 file, an AVI file, a JPEG; a GIF, a TIFF, and a text file.

65. The system of claim 36, wherein the advertising presentation device comprises a user interface for providing a user with access to a service.

66. The system of claim 65, wherein the service is access to a computer network.

67. The system of claim 65, wherein the service is access to a telephone network.

68. The system of claim 36, wherein at least the advertising presentation device is mounted to a vehicle.

69. The system of claim 68, wherein the controller comprises an input interface configured to received operation data of the vehicle.

70. The system of claim 36, wherein the controller is further for:
collecting and reporting data related to the status of, and display of advertising on, the advertising presentation device.

71. The system of claim 36, wherein the controller further comprises a transceiver for communicating and sharing data with another controller of another proximate one of the system.

72. A computer readable medium embodying a computer program for operating an advertising presentation device, the computer program comprising:
computer program code for regularly receiving electronic context data related to the advertising presentation device;
computer program code for, on the basis of the context data, automatically generating context-based advertising; and
computer program code for causing the advertising presentation device to present the context-based advertising.

73. A method of presenting dynamic advertising, comprising:
providing an advertising presentation device in communication with a controller;
the controller regularly receiving electronic context data related to the advertising presentation device;
the controller automatically generating context-based advertising on the basis of the context data; and
the controller causing the advertising presentation device to present the context-based advertising.
